(19) United States
(12) Patent Application Publication
(10) Pub. No.: US 2002/0120484 A1
(43) Pub. Date: Aug. 29, 2002

(54) Method and system for providing intelligent rules-based engine with heuristics for determining optimal routing and processing of business events

(75) Inventors: David F. Bantz, Chappaqua, NY (US); Thomas E. Chefalas, Somers, NY (US); Steven J. Mastrianni, Unionville, CT (US); Ajay Mohindra, Yorktown Heights, NY (US)

Correspondence Address: F. CHAU & ASSOCIATES, LLP, Suite 501, 1900 Hempstead Turnpike, East Meadow, NY, 11554, US

(73) Assignee: International Business Machines Corporation, Armonk, NY (US)

(21) Appl. No.: 09/791,933

(22) Filed: Feb. 23, 2001

(51) Int. Cl. G06F 17/60

(52) U.S. Cl. 705/8

(57) ABSTRACT

A method and system for routing and servicing events provides a communication link which carries event messages communicated to a computer network. A router listens for the event messages of a given type and routes the event messages to a destination corresponding to the given type. A service controller is coupled to the at least one router, and the service controller maps the event messages routed thereto by the at least one router to commands to perform services.

### BACKGROUND OF THE INVENTION

1. Field of the Invention

The present invention relates to computer systems, and more particularly to a system and methods which provide an intelligent rules-based engine with heuristics for determining the most optimal routing for and processing of business events on a service-provider network.

2. Description of the Related Art

Computer system networks, for example, client/server systems, currently enjoy widespread use. These systems include common resources on a server which may service a plurality of client systems. The increasing cost of installing and maintaining computer systems has become a focal point for industry initiatives to lower the total cost of ownership, or TCO. A large number of companies or have developed or are developing products and technologies to lower the TCO. While TCO primarily addresses the hardware with various types of instrumentation and monitoring tools, a large portion of the cost of deploying computer systems comes from the need to maintain a costly information technology (IT) organization. The IT organization deploys software and applications for use by the organization's workers, This ensures that the software is installed and functioning properly.

Because the cost of the IT organization is high, the ability to automate a part or parts of the IT processes is highly desirable. In response to this, several organizations have implemented and deployed some level of automatic software installation and software update capability. Several of these systems include basic platform services such as backup and restore. These simple platform services are generally provided by an application service provider (ASP) or data center, and provide end-user companies with one less IT function to worry about. Software installation has begun to appear as another IT function that can be outsourced, although the many different application packaging formats have hindered deployment. Backgup, restore, and software installation are three types of platform services, but they do not address the higher-level services that are needed for IT automation.

Therefore, a need exists for an information technology services platform that provides higher-level IT services, adapts business events into the system and optimizes workflow for handling the business events.

### SUMMARY OF THE INVENTION

A method and system for routing and servicing events, in accordance with the present invention, provides a communication link which carries event messages communicated to a computer network. A router listens for the event messages of a given type and routes the event messages to a destination corresponding to the given type. A service controller is coupled to the at least one router, and the service controller maps the event messages routed thereto by the at least one router to commands to perform services. The present invention relates to a system and methods, preferably implemented in software, to provide intelligent automatic routing of business events. In one embodiment, the present invention is employed on a subscription-based, provider's network. The present invention employs a visible and controllable platform, systems management and other business services that signal events and accept commands.

The software implementation includes a communications system that transports events, commands and other messages; a router that directs messages to the appropriate destinations, and (one or more) controllers that map events to sequences of commands to services, ultimately to accomplish an IT operational goal. The software sits “on top” of the managed systems' platform services, providing a high-level, intelligent routing mechanism for events. Events can be platform events (events related to the IT infrastructure) or business events (events concerning business processes).

One component of the present invention that is responsible for the intelligent routing of messages includes a routing engine. The routing engine fields events from the client systems and forwards the events to one or more of the service controllers. The routing engine and controllers may be installed locally at the customers' site or at a remote location where the client systems are being managed. The routing of events to and from a remote location need a connection, which can be a permanent connection such as a digital subscriber line (DSL), satellite, cable, or even a dial-up connection.

The routing engine may be configured to route certain events to either the local controllers or to the remote controllers. This permits local autonomy for the customer in the event that a permanent connection does not exist, has been lost, or is not available.

A browser-based interface to the controller permits a business owner to easily configure the responses to events and to specify the workflow. The event configuration and workflow can be changed locally or remotely using the browser-based interface as well. The tools may employ visual objects to represent business processes, events and actions, and permits the user to visually configure events and services without knowledge of the underlying mechanisms. The resultant configuration is represented in new procedures that are automatically emitted by the tool and incorporated in a revised operational process. The tool also serves as a visual workflow configuration tool that permits the user to observe how a particular event will be handled.

One example of business event handling may include the actions taken to add an employee to a company system or database. The manager of a human resources staff enters the relevant employee information such as address, phone number, assigned department, salary, and other data. The user is then presented with a menu of services that can be invoked, such as “Assign a parking space,” “Schedule new employee orientation,” “Add to company organization chart” and “Sign up for company life insurance.”

When the employee record is submitted, the present invention determines the type of operation and automatically routes the relevant information to the proper applications that perform the functions. The routing can be synchronous or asynchronous, allowing some tasks to be performed in parallel and others to be performed in a particular sequence.

The system logs the configuration and the result of the previous operations including the start time, end time, and results of each step in the handling of a business event. Using this data, the event router “learns” how to more efficiently manage and schedule each function in the processing of business events. For example, if the process of getting users Id's for a new employee takes 24 to 48 hours, that process can be invoked immediately before any others are started to maximize efficiency of the requests. When the user configures a new service, the existing data is reviewed to provide a recommended routing based on the past results and rules criteria. The service may be installed on a local server or a remotely located server. The connection to the remote server may not be fixed, and may be a simple dial-up connection. If an event occurs that needs a remote service, the router checks for an active connection, and if found, invokes the service.

If, however, the connection does not exist, the call to the service is queued up by the local server for dispatch at a later time. Each subsequent service function is then checked against the rules engine to see if the service can be invoked in parallel, before the remote service finishes. If so, those services are invoked and the results queued on the local server. When a connection is finally established, the remote service is invoked and the status combined with other service status retained on the local server and the service invocation is marked complete.

If the service invocation rules state that the service must be completed in a specific time and the service gets queued up at the local server, the queue list is reordered by the queue manager when a connection is instantiated to make sure that the most urgent requests get completed first. Certain combinations or “patterns” of events occur which indicate that certain other services should be invoked as a result. These patterns may include collections of events that occur over a given time span and collectively represent a condition or “situation” that is not readily determined by the occurrence of any one or more of these events except when they occur within close proximity of each other and collectively are identified by the rules engine as a recognized pattern. Over time, the rules engine keeps track of frequently recurring events and patterns, and saves these event combinations as proposed new “situations,” and allows the user to use the new situations to configure the present invention.

The manager or administrator configures how the system reacts to events using, for example, a visual browser interface. Using the visual interface, the administrator can view how events will be handled using the events routing simulator The browser interface can also be used to monitor the software bus providing real-time status of events as the events are being handled.

These and other objects, features and advantages of the present invention will become apparent from the following detailed description of illustrative embodiments thereof, which is to be read in connection with the accompanying drawings.

### BRIEF DESCRIPTION OF DRAWINGS

The invention will be described in detail in the following description of preferred embodiments with reference to the following figures wherein:

FIG. 1 is a schematic diagram illustrating a service-provider network configuration according to the present invention;

FIG. 2 is a block/flow diagram illustrating a system/method for a business event router mechanism in accordance with the present invention;

FIG.3 is a block/flow diagram illustrating a system/method for workflow optimization in accordance with the present invention; and

FIG. 4 is a block/flow diagram illustrating a system/method for providing an event handling and routing service in accordance with the present invention.

### DETAILED DESCRIPTION OF PREFERRED EMBODIMENTS

The present invention is directed to systems and methods for automating information technology (IT) systems. The present invention provides higher-level IT services, adapts business events into the system and optimizes workflow for handling the business events. An example of an IT service may include the ability to add an employee to an organization's system. In this example, the action of adding an employee also permits the user to perform other higher-level actions, such as allocation of an office, obtaining a company credit card, assigning a parking space, scheduling an orientation class, and requesting computer users Ids and passwords. Other IT services may include catalog generation, data mining, workflow, and application integration. The capability of automatically coordinating and exercising these mechanisms to accomplish an IT operational goal may include, for example: instantiating a new business service, adding a new client or resolving a broker IT capability advantageously providing IT services automation.

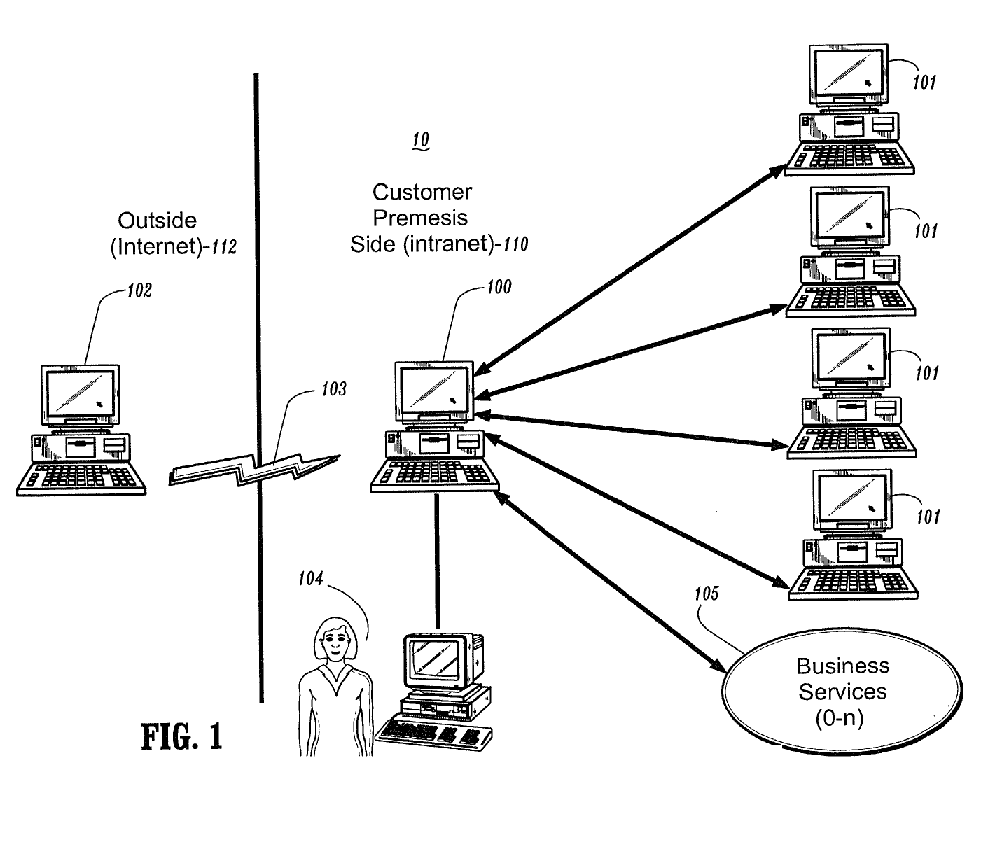

It should be understood that the elements shown in FIGS. 1-3 may be implemented in various forms of hardware, software or combinations thereof. When these elements are implemented in software, one or more appropriately programmed general purpose digital computers are employed having a processor and memory and input/output interfaces which execute the software applications. Referring now to the drawings in which like numerals represent the same or similar elements and initially to FIG. 1, a network configuration 10 is shown upon which a local server 100 is employed. Local server 100 includes a service module 105 in accordance with the present invention. Service module 105 preferably include application software which will be described in greater detail herein. The local server 100 is connected to one or more client systems 101 which are managed by the local server 100 through a browser interface 104.

The client computers 101 include an operating system such as, for example, Windows 95®, Windows 98®, Windows NT®, Linux® or any other operating system. The client computer 101 include hardware adapters such as a modem, cable modem, digital subscriber line (DSL) modem, token-ring, Ethernet, or wireless equivalents of the same to connect to the network local server 100.

The client computer or client 101 also includes appropriate software drivers installed to enable the client 101 to use TCP/IP communication protocol or any other communication protocol over the hardware adapters to send data to and receive data from the local server 100. In addition, the client computer 101 may include all the software applications that a user may employ to manage routine information management tasks. These applications may include a web browser and mail clients. The web browser can be embodied by, for example, Netscape® or Microsoft's Internet Explorer®, connection management can be embodied by AT&T's Global network dialer; and mail clients can be embodied by, for example, Lotus Notes®, Microsoft Outlook®, or Eudora®.

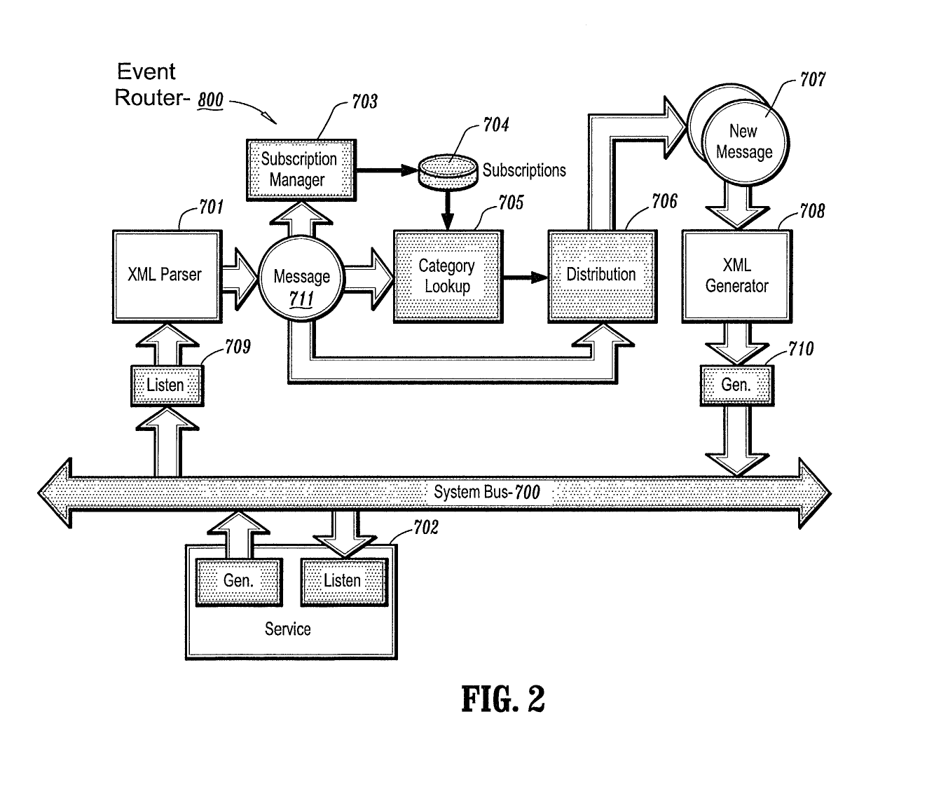

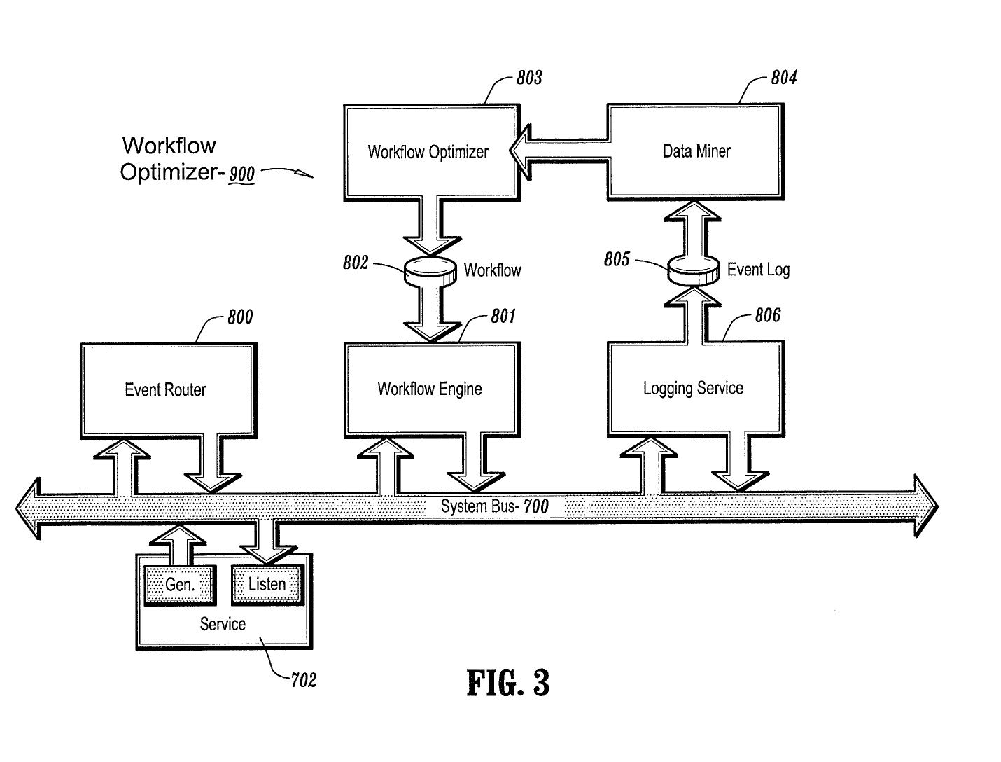

Specialized software applications and components referred to as business services or business processes 105 are installed on systems, preferably systems which are located on a customer's intranet 110. These services 105 provide specialized or generic functions for the business or other organizational entity. These services 105 can also be installed on the Internet 112 by a service provider on a system 102 to provide value added services to a customer business or client. A fire wall 103 may be provided to limit access to and from the outside (e.g., the Internet) 112 These services 105 can be invoked by a service generator, normally the local server 100 to provide added functionality. Services that generate or translate business events are called event generators. A service can also be both an event listener and an event generator (See e.g., FIGS. 2 and 3).

Services 105 can “sign up” to be notified of specific business events or classes of business events. An example of a business event may include the hiring of a new employees, and a class of business events may include the relocation of a business unit where a group of employees receive, for example, a new business address. The event generator in the local server 100 filters business events and sends a notification of the occurrence of a particular business event to all of the listeners that have requested notification. A service may elect to listen to all events yet provide no response or event generation of its own. An example of this would be a passive event monitor.

The client computer(s) 101 are used by customers to run business applications and other software such as e-mail programs and Internet access software. The local server 100 acts as an administrator to the client computers 101 by interpreting messages and events that are generated by the client computer 101. The local server 100 also generates events in the form of messages to the client computer 101. The server-generated events are sent to those components that have previously registered with the local server 100 and sent to specialized components specified by the configuration program 104 that perform specific business processes or services 105.

When a specialized component 105 receives a business event message from the local server 100, the component 105 performs the requested actions(s) and returns the status of the request to the local server 100. Based on the value of the returned status, the local server 100 may reissue the same event or a collection of events to the same component 105 or other installed components.

A browser-based interface of the controller 104 permits a business owner or other user to easily configure the responses to events and to specify the workflow. The event configuration and workflow can be changed locally or remotely using the browser-based tool. The tool 104 uses visual objects to represent business processes, events and actions, and permits the user to visually configure events and services without knowledge of the underlying mechanisms. The resultant configuration is represented in new procedures that are automatically emitted by the tool and incorporated in a revised operational process. The tool 104 also serves as a visual workflow configuration tool that permits the user to observe how a particular event will be handled. Referring to FIG. 2, data flow through an event router 800 is shown. A system bus 700 connects various system components or computers (e.g., computers 100, 101 and/or 102). Components on a system bus 700 can be event listeners, event generators, or both. Each component, whether it is a listener, generator, or both, is registered with a subscription manager 703 in a subscription storage 704 to indicate which type of message the component is interested in receiving. For example, a component that provides payroll services would register to receive any messages related to payroll functions, but not those messages related to program installation.

As an example, a notification service 702 is installed on a client system 101 (or system 100, or system 102) with the purpose of notifying this system administrator if the disk on the client system 101 becomes full. The service software 702 in the client computer 101 generates a message on the system bus 700 that the disk drive in the client computer 101 has become full. A listener 709 reads the message from the system bus 700 and passes the message on to an extensible Markup Language (XML) parser 701, which partially decodes the message to create a at least a partially decoded message 711. A category lookup 705 determines that a service technician service has registered with subscription manager 703 prior to the receipt of the message. The service technician service will dispatch a system technician, checking the system configuration to see if another disk can be added to the client system 101, and checking the parts inventory to see if another disk can be added to the client system 101, and checking the parts inventory to see if another disk is currently in stock. Category lookup 705 determines the recipients of the message and passes the information to a distribution mechanism 706. The new message(s) 707 are then encoded by XML generator 708, then placed on the system bus 700 where the responsible component listeners “see” the message and act upon it.

The event router 800 illustrated in FIG. 2 includes the function of routing messages based on the contents of a category field within the message and the current subscriptions to that message category represented by the subscriptions database 704. Router 800 may be included on one or more of systems 100, 101 and/or 102, depending on a particular configuration and functions of a particular system. The message is replicated, if necessary and new messages addressed directly to recipients listed in the subscriptions database 704, are then encoded and sent. Advantageously, this function permits recipients to be added to or deleted from the system without notification to event sources. It also implements logical multicasting of messages when more than one service is interested in receiving a message of a given category.

Subscription manager 703 is called when messages of a reserved category, e.g., the “subscription management” category are received by listener 709. One purpose of the subscription manager 703 is to update the subscriptions database 704, either by registering a new subscription or by canceling an existing one. Subscriptions may include a pair of the form (category, recipient-address), where the category is the message category of messages that the subscriber wishes to receive. The recipient-address is the specific address of the subscriber. Note that the category field may be partially-specified, so that multiple message categories can be designated in a single subscription. For example, categories may include business news, sporting news and political new. However, the category field having and entry of “news” can provided updates for all three of these news categories.

Subscriptions may also have leases, or time windows during which the subscription is valid. Thus messages of the subscription management category also may include a lease field, which may be empty. If empty, the lease is assumed to be some default value. If the current time is greater than the maximum time given in a lease the subscription will be automatically canceled. Leases prevent subscriptions from accumulating in the database when subscribers terminate abnormally.

Referring to FIGS. 1 and 2, event updates may be originated at clients 101 and connected by a communication link 103 to an outside computer system or server 102 and/or a local server 100. Routers 800 in accordance with the present invention may be included on systems 102, 101 and/or 100 and listen for events or updates from systems 100 or clients 101, respectively. Customer(s) 100 or 101 may subscribe to routing and servicing of their computer system for updates with respect to business events including new employees, enrollment in organizational groups, marketing lists, telephone directories or any other information. Services which employ the present invention may include news, such as local news, company news, business unit news, posting of promotions, hirings, firings or any other information which needs to be updated.

In one example, the customer of system 100 subscribes to a service provided by a service provider. The service may be installed on a local server 100 or a remotely located server 102. When the user 104 configures a new service, the existing data is reviewed to provide a recommended routing based on past results and rules criteria. The service provider may charge the client for usage time, amount of data transferred, number of transactions or any other suitable fee schedule.

The connection to the remote server 102 may not be fixed, and may be a simple dial-up connection. If an event occurs that needs a remote service, the router checks for an active connection, and if found, invokes the service. If, however, the connection does not exist, the call to the service is queued up by, e.g., the local server 100 for dispatch at a later time. Each subsequent service function is then checked against the rules engine to see if the service can be invoked in parallel, before the remote service finishes. If so, those services are invoked and the results queued on the local server 100. When a connection is finally established, the remote service is invoked and the status combined with other service status retained on the local server and the service invocation is marked complete.

If the service invocation rules state that the service must be completed in a specific time and the service gets queued up at the local server 100, the queue list is reordered by a queue manager when a connection is instantiated to remote server 102 to make sure that the most urgent requests get completed first.

In one embodiment, a service controller 720 may provide a billing service. The billing service may be employed on any computer preferably at the service provider to keep track of services used by each client (subscriber). In this way, billing of identified clients can be performed for services rendered.

Referring to FIG. 3, components of a system/method for workflow optimization 900 are shown. Service 702 is presumed to generate an event, such as, a business event, for example the arrival of a new employee. This is preferably performed by modifying, e.g., an existing personnel application to generate the needed event. The event is routed via an event router 800 to both a logging service 806 and a workflow engine 801. The workflow engine 801 generates a sequence of events which activate other services not shown in the figure to accomplish the necessary steps in the business process. An example of a workflow engine is IBM MQSeries Workflow®. These events are also logged by logging service 806.

At the completion of a workflow 802, logging service 806, which has been creating an event log 805, releases the event log 805 to a data miner 804. Data miner 804 analyzes the sequences of events recorded in event log 805 to determine patterns, for particular situations or sequences. For example, the hiring of a new employee includes several steps, for instance assign an office, assign a phone number and assign a parking space. This sequence may be performed in a special order and include particular steps. Once these patterns have been detected they are supplied to a workflow optimizer 803. Workflow optimizer 803 analyzes these patterns to determine potential optimizations. These optimizations are performed in accordance with logical or predetermined rules. For example, an office assignment is needed for a new employee before a phone number may be assigned since the phone number is dependent of the location of the new employee. As these optimizations are discovered, they cause workflow optimizer 803 to modify workflow 802, either directly or by creating workflow versions. Workflow engine 801 can then use this new version or these new modifications to implement the revised process.

Optimizations of optimizer 803 may rely on patterns learned from previous processes, criteria programmed by a system administrator or other user or objective criteria such as processing time, available resources, etc.

Event log 805 captures event messages indicative of an actual sequence and time of occurrence of events. The events of relevance to workflow optimizer 803 concern the origination and completion of process steps. Accordingly, data miner 804 produces traces of events relating to specific process steps or workflow sequences. For example, event log 805 includes a list of all events to which the event log has subscribed, e.g., ordered by time of arrival. Data miner 804 analyzes this list and isolates sequences of events that are related. The criteria for determining “relatedness” is set by rules driving data miner 804. These rules are preferably created in accordance with specific workflow optimizations to be performed by workflow optimizer 804. Rules may include a particular order of execution of steps or placement of events to improve data flow, processing time, computing resource allocation etc.

As an example, workflow engine 801 may issue a sequence of messages to services 702, each including a unique identifier I of a work flow. That work flow may be initiated in response to the arrival of a new employee, as described above. Messages of all types may be recorded by logging service 806, but data miner 804 may scan event log 805 and extract messages including unique identifier I.

Workflow optimizer 803 then analyzes the message sequence received form data miner 804. Workflow optimizer 803 performs the analysis in accordance with rules. These rules may be set in accordance with the processes to be performed, priorities of process steps or events, arrival times, etc. For example, one rule may require workflow optimizer 803 to compute elapsed time between the first message of a sequence and the last message of that sequence. If this elapsed time is less than a time interval given in the rule no further action is performed. Such a rule would check to see if all process steps to add a new employee had been performed in less than 48 hours, for example. It is to be understood that rules for optimizing flow may set by clients or a service provider. The rules may include any number of criteria having any suitable form for which a specific service, process step or sequence can be measured.

If a rule fails, further rules may be applied to further analyze the event sequence, for example, detecting that a particular process step was consistently taking more time than expected. Workflow optimizer 803 may now suggest or perform various optimizations concerning this step. For example, by analyzing a dependency graph of the process steps maintained as part of the workflow 802, rules may find that the lengthy process step could be started earlier in the workflow. Alternately, workflow optimizer 803 may consult a database of resource allocations to process steps, also included in workflow 802, and determined that additional resources may be allocated to the lengthy process step. In this manner workflow optimizer 803 transforms workflow 802 to a more optimal form.

Workflow optimizer 803 may be resident on local server 100, remote server 102 or a client system 101. Workflow optimization may be offered as a service to subscribers to analyze and optimize the routing and handling of events in accordance with the present invention.

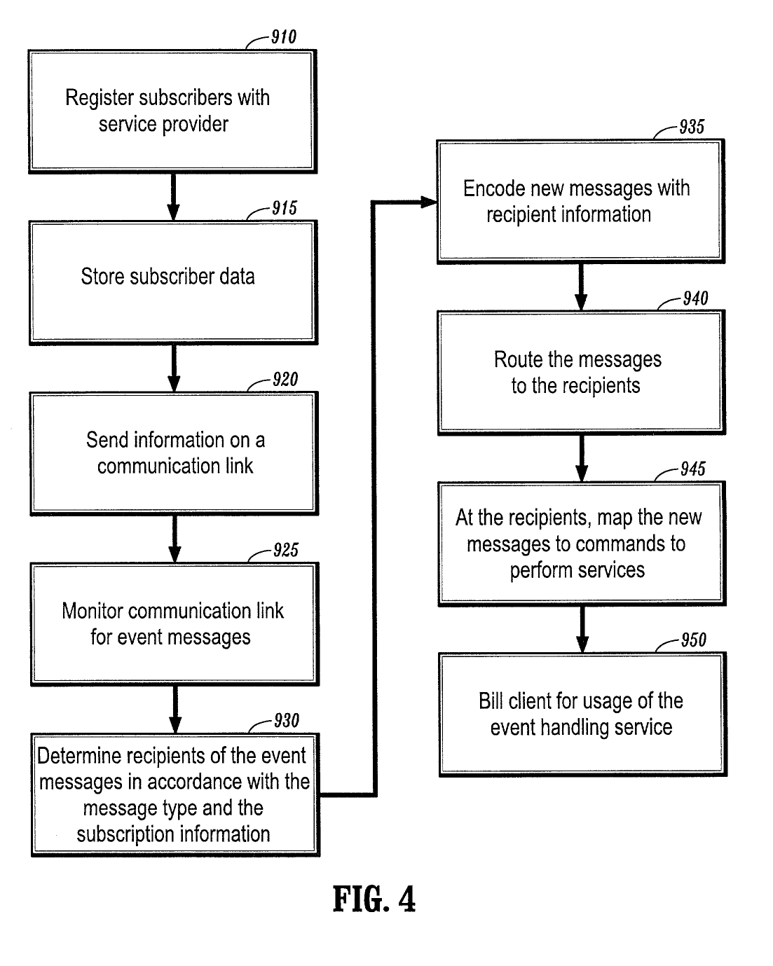

Referring to FIG. 4, a block/flow diagram is shown for a system/method for providing event routing services for a subscriber-based system in accordance with the present invention. In block 910, subscribers sign up and are registered for services with a service provider. Subscribers may include clients servers, client subsystems (e.g., desktop computers), objects resident on client computers, software applications, databases or any other definable destination. Subscriber data includes an identification code capable of uniquely identifying a particular subscriber or class of subscribers. This code is stored in subscription storage 704 of each router 800 (FIG. 2), in block 915.

In block 920, information is exchanged on a communication link. In one example, a new employee is entered into a client system 101 and is communicated to service provider (e.g., server 102 or alternately system 100). The message type being a new employee message type for that particular client.

In block 925, the service provider monitors a communication link which carries event messages communicated to a service provider by the client systems. In block 930, the messages are decoded by parsing the event messages to determine subscriptions associated with the event message in a router (800) and to determine proper routing of the event messages. Messages will be correlated to subscribers who are to receive the event messages. In block 935, information about the recipients of the messages is encoded into new messages which will be received only by subscribers of that particular message type. This permits the exclusion of other subscribers from receiving the new messages. Advantageously, a plurality of different clients or entities may employ the same communication link, but will be precluded from receiving messages to which they are not subscribers. In block 940, the event messages are routed from the service provider to destinations. The event messages may be prioritized by, for example, the type of message or by the age of the message. In block 945, the new messages are mapped at the destinations to commands to perform services.

In block 950, billing of subscribers for usage of the event routing services is performed. Billing may be based on the amount of use, the size of the messages, the number of event messages, the type of service, or any other method for service billing. For example, billing subscribers may include billing for analyzing there internal information technology processes and optimizing their usage based on previous usage patterns to determine workflow improvements.

Having described preferred embodiments of a system and method for providing intelligent rules-based engine with heuristics for determining optimal routing and processing of business events (which are intended to be illustrative and not limiting), it is noted that modifications and variations can be made by persons skilled in the art in light of the above teachings. It is therefore to be understood that changes may be made in the particular embodiments of the invention disclosed which are within the scope and spirit of the invention as outlined by the appended claims. Having thus described the invention with the details and particularity required by the patent laws, what is claimed and desired protected by Letters Patent is set forth in the appended claims.

What is claimed is:

1. A system for routing and servicing events, comprising:
a communication link which carries event messages communicated to a computer network;
at least one router which listens for the event messages and routes the event messages to a destination based on subscriber information corresponding to a given type of message; and
at least one service controller coupled to the at least one router, the at least one service controller maps the event messages routed thereto by the at least one router to commands to perform services.

2. The system as recited in claim 1, wherein the at least one router includes a subscription manager which determines whether the event messages include a subscription to which the at least one service controller is responsive.

3. The system as recited in claim 2, further comprising a parser which decodes the event messages to determine subscriptions associated with the event message.

4. The system as recited in claim 1, wherein the at least one router includes category lookup information which determines recipients of the given type of message.

5. The system as recited in claim 1, wherein the at least one router includes a distribution mechanism which generates a new message with identities recipients for content of the event messages.

6. The system as recited in claim 5, wherein the at least one router includes a generator coupled to the communication link to output the new message such that a service controller coupled to the communication link is identified and is responsive to the new message.

7. The system as recited in claim 1, further comprising a workflow engine coupled to the communication link, the workflow engine generates a sequence of events which activate service controllers to perform a process.

8. The system as recited in claim 1, further comprising:
a logging service coupled to the communication link, the logging service generates an event log of activities of the system; and
a data miner which analyzes the event log to determine patterns in the activities of the system.

9. The system as recited in claim 8, further comprising a workflow optimizer which receives information about the patterns determined by the data miner, the workflow optimizer analyzes the patterns to determine workflow improvements based on rules for optimization.

10. A method for routing and servicing events, comprising the steps of:
monitoring event messages on a communication link of a computer network;
determining a message type of the event messages;
identifying recipients of the event messages in accordance with the message type;
outputting new messages, which include information in the event messages, on the communication link, the new messages being identifiable by the recipients of the new messages; and
servicing the new messages by the recipients which include service controllers which map the event messages to commands.

11. The method as recited in claim 10, wherein the step of determining a message type of the event messages includes the steps of:
decoding the event messages to determine subscription information included in the event messages; and
comparing the subscription information with stored subscriptions to determine the message type.

12. The method as recited in claim 10, wherein the step of identifying recipients of the event messages in accordance with the message type includes the step of looking up subscription information in accordance with the message type to determine recipient service controllers.

13. The method as recited in claim 10, further comprising the step of providing a workflow engine coupled to the communication link to generate a sequence of events which activate service controllers to perform a process.

14. The method as recited in claim 10, further comprising the steps of:
generating an event log of activities of the system by employing a logging service coupled to the communication link; and
analyzing the event log to determine patterns in the activities of the system.

15. The method as recited in claim 14, further -comprising a workflow optimizer which receives information about the patterns determined in the step of analyzing the event log, and further comprising the step of analyzing the patterns to determine workflow improvements based on rules for optimization.

16. A program storage device readable by machine, tangibly embodying a program of instructions executable by the machine to perform method steps for routing and servicing events, the method steps comprising:
monitoring event messages on a communication link of a computer network;
determining a message type of the event messages;
identifying recipients of the event messages in accordance with the message type;
outputting new messages, which include information in the event messages, on the communication link, the new messages being identifiable by the recipients of the new messages; and
servicing the new messages by the recipients which include service controllers which map the event messages to commands.

17. The program storage device as recited in claim 16, wherein the step of determining a message type of the event messages includes the steps of:
decoding the event messages to determine subscription information included in the event messages; and
comparing the subscription information with stored subscriptions to determine the message type.

18. The program storage device as recited in claim 16, wherein the step of identifying recipients of the event messages in accordance with the message type includes the step of looking up subscription information in accordance with the message type to determine recipient service controllers.

19. The program storage device as recited in claim 16, further comprising the step of providing a workflow engine coupled to the communication link to generate a sequence of events which activate service controllers to perform a process.

20. The program storage device as recited in claim 16, further comprising the steps of:
generating an event log of activities of the system by employing a logging service coupled to the communication link; and
analyzing the event log to determine patterns in the activities of the system.

21. The program storage device as recited in claim 20, further comprising a workflow optimizer which receives information about the patterns determined in the step of analyzing the event log, and further comprising the step of analyzing the patterns to determine workflow improvements based on rules for optimization.
